(19) United States
(12) Patent Application Publication
(10) Pub. No.: US 2011/0243308 A1
(43) Pub. Date: Oct. 6, 2011

(54) RECOGNITION DEVICE FOR SAFELY INDENTIFYING THE LEFT OR RIGHT PORTION IN RADIOLOGIC EXAMINATION

(75) Inventor: WING-PONG CHAN, Taipei City (TW)

(73) Assignee: TAIPEI MEDICAL UNIVERSITY, TAIPEI CITY (TW)

(21) Appl. No.: 12/941,325

(22) Filed: Nov. 8, 2010

(30) Foreign Application Priority Data
Mar. 30, 2010 (TW) 099205577

(51) Int. Cl. H05G 1/28

(52) U.S. Cl. 378/165

(57) ABSTRACT

The invention discloses a recognition device for safely indentifying a left or right portion in a radiologic examination, comprising a plurality of puzzle pieces and a plurality of labels. Every puzzle piece comprises a pattern, and the pattern can be one portion of a picture corresponding to an organism to be analyzed. The portion can comprise a left anatomical portion or a right anatomical portion. Each label is respectively disposed in each the puzzle pieces or on the surface thereof. When the plurality of puzzle pieces are irradiated by X-ray, the outline of each of the positions or labels is developed on a film.

### FIELD OF THE INVENTION

The present invention relates to a recognition device, and more particularly, to a recognition device for safely indentifying a left or right portion in a radiologic examination.

### BACKGROUND OF THE INVENTION

X-ray is a form of electromagnetic radiation, and the wavelength thereof is within a range of 0.01 to 10 nanometers. X-rays are generated by an X-ray tube or vacuum tube that uses a high voltage to accelerate the electrons released by a hot cathode to a high velocity. The high-velocity electrons collide with a metal target, the anode, creating the X-rays. X-rays have been used for medical diagnosis since their discovery in 1895. The X-ray has penetrating abilities, and can pass through various materials. Because organs and bones in a human body have different densities, images showing different depths are developed on the X-ray film while X-ray is projected through a part of the body. For example, the bones are represented by a white color and the lung is represented by a black color on the X-ray film. Furthermore, lead can shield the body against X-rays completely because of its high density. To sum up, images on the X-ray film can be used for disease diagnosis, such as fractures or lung diseases, due to the image having different, contrasting colors.

A lead tile marked “R” or “L” is used for marking the direction of the anatomical position or the direction of radiating X-rays in most hospitals. The lead tile indicates not only “R” and “L”, but also may have other labels. R represents right, and L represents left. For example, when the fractured right hand of a patient is irradiated by X-rays, the lead tile marked “R” can be placed near the right hand of the patient to be irradiated by the X-ray simultaneously. Thus, the bone of the right hand and the letter “R” are shown contiguously on the X-ray film. However, under emergency conditions, radiologists need to quickly find the correct tile from the lead pieces in a box or scattered on the desktop. It is time-consuming in practice, and the probability of error may be high. Additionally, when there are many cases, the probability of placing the wrong lead tile marked “L” or “R” in error is increased for new radiologists or even for skilled radiologists.

### SUMMARY OF THE INVENTION

In view of the aforementioned drawbacks in current practice, an object of the present invention is to provide a recognition device for safely indentifying a left or right portion in a radiologic examination, so as to decrease the probability of picking the wrong lead pieces by radiologists.

To achieve the above object, the recognition device comprises a plurality of lead pieces, like puzzle pieces, and a plurality of labels. Each of the plurality of puzzle pieces comprises a pattern, and the pattern is a portion of a picture corresponding to an organism to be analyzed. The portions comprise a left anatomical portion and a right anatomical portion. The plurality of labels are disposed in the plurality of puzzle pieces or on the plurality of puzzle pieces and corresponding to each of the portions. When various puzzle pieces are irradiated by X-ray, the outline of each of the portions or labels is developed on a film.

Accordingly, the recognition device for safely indentifying a left or right portion in a radiologic examination according to the present invention provides one or more of the following advantages:

(1) Because the directions of the corresponding picture on the puzzle pieces in the present invention are the same as those of a patient, the radiologists can rapidly and accurately find puzzle pieces with correct directions or portions under large and regular radiologic examinations or emergency examinations, thereby decreasing the probability of picking the wrong puzzle pieces.

(2) The recognition device of the present invention comprises a puzzle piece marked “standing”, “flexion”, “extension”, “prone”, “supine”, “right anterior oblique (RAO)”, “right posterior oblique (RPO)”, “left anterior oblique (LAO)”, “left posterior oblique (LPO)”, or “minutes”. When the above puzzle pieces and the portion of a patient are simultaneously irradiated by X-ray, the above words are shown on the film so that the radiologist recognizes accurately the irradiated portion of the patient. The “minutes” represents the time after taking an oral contrast medium or injecting a contrast medium via intravenous injection, such that the radiologists can easily detect the irradiation time.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic diagram illustrating a recognition device for safely indentifying a left or right portion in a radiologic examination according to the first embodiment of the present invention;

FIG. 2 is a schematic diagram illustrating a mark shown on a film after radiating X-ray onto a recognition device of the present invention;

FIG. 3 is a schematic diagram illustrating a recognition device for safely indentifying a left or right portion in a radiologic examination, according to a second embodiment of the present invention;

FIG. 4 is a schematic diagram illustrating a recognition device for safely indentifying a left or right portion in a radiologic examination according to a third embodiment of the present invention; and

FIG. 5 is a schematic diagram illustrating a recognition device for safely indentifying a left or right portion in a radiologic examination according to a fourth embodiment of the present invention.

### DETAILED DESCRIPTION OF THE PREFERRED EMBODIMENTS

The present invention will now be described with some preferred embodiments thereof with reference to the accompanying drawings. It is understood that the experimental data shown in the embodiments are provided only for easy interpretation of the technical means of the present invention and should in no means be considered as restriction of the present invention.

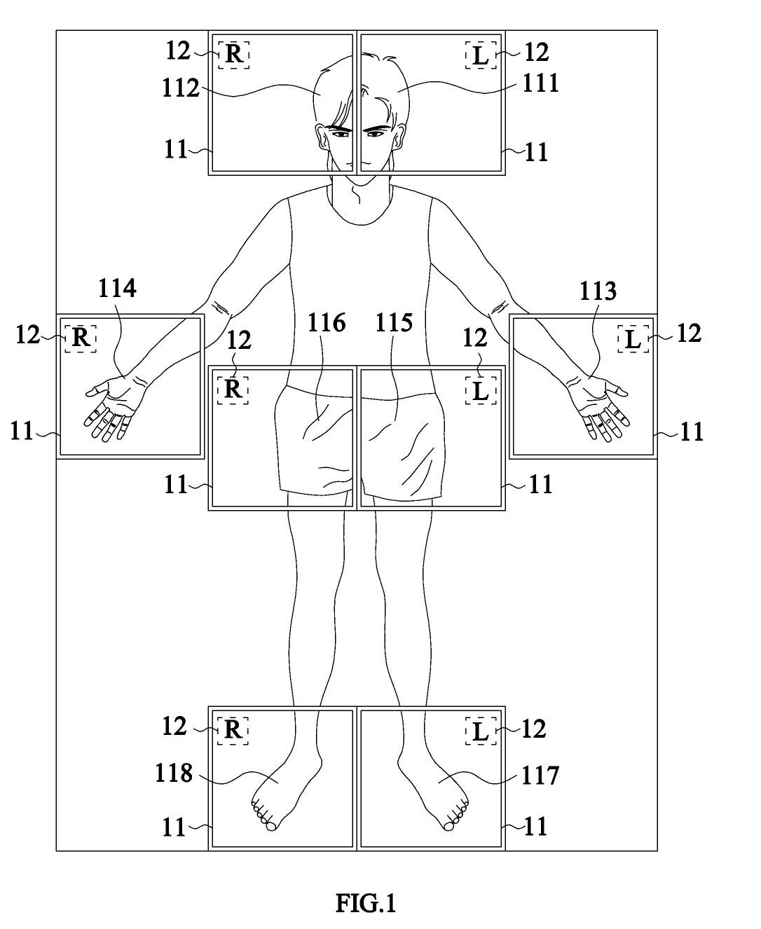

Please refer to FIG. 1, which is a schematic diagram illustrating a recognition device for safely indentifying a left or right portion in a radiologic examination according to the first embodiment of the present invention. As shown, the recognition device comprises a plurality of puzzle pieces 11. Each of the plurality of puzzle pieces 11 comprises a pattern, and the pattern can be a portion of a picture corresponding to an organism to be analyzed. The portions comprise a left anatomical portion and a right anatomical portion. In the present embodiment, the organism to be analyzed may be a human, and the picture corresponding thereto can be the front view of the outline of the human. Therefore, the pattern can be a left anatomical portion or a right anatomical portion, which may be a left head portion 111, a right head portion 112, a left hand portion 113, a right hand portion 114, a left pelvic cavity portion 115, a right pelvic cavity portion 116, a left foot portion 117 or a right foot portion 118.

Additionally, the recognition device comprises a plurality of labels disposed in the plurality of puzzle pieces or on the plurality of puzzle pieces and corresponding to each of the portions. The plurality of labels can include a mark 12 corresponding to the left anatomical portion or the right anatomical portion. In the present embodiment, when the pattern is the left head portion 111, the mark 12 thereof is “L”. When the pattern is the right head portion 112, the mark 12 thereof is “R”. Another example, when the pattern is the left hand portion 113, the mark 12 corresponding thereto is “L”. When the pattern is the right hand portion 114, the mark 12 corresponding thereto is “R”. And so on: the mark 12 may be “L” or “R” corresponding to the markings in the puzzle pieces or on the puzzle pieces, and therefore is not repeated herein. Thus, when the plurality of puzzle pieces are irradiated by X-ray, the mark of each of the portions is developed on a film.

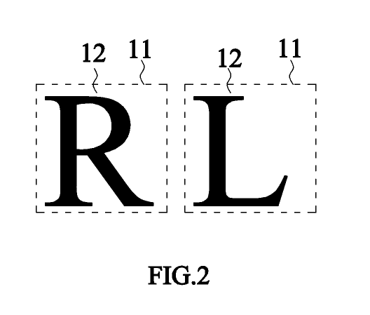

In a preferable embodiment, the mark 12 “L” or “R” can be inserted into each of the puzzle pieces 11, and the size of the mark 12 is the same as the size of each puzzle piece 11. For opaque puzzle pieces 11, because the mark 12 is on the inside of each of the puzzle pieces 11, the mark 12 is not visible on the puzzle pieces 11. Meanwhile, another mark 12 with a smaller size may be displayed on the surface of the puzzle pieces 11 to make them easily seen by radiologists. When the puzzle pieces and a patient are simultaneously irradiated by X-ray, the mark 12 inserted in the puzzle piece 11 can be shown on the X-ray film, and the small mark 12 on the surface of the puzzle piece 11 is not shown on the X-ray film. Because the size of the mark 12 inserted into the puzzle pieces 11 almost equals the size of the puzzle piece 11, the mark 12 shown on the X-ray film is much bigger than the surface mark, as shown in FIG. 2. Therefore, the radiologist can accurately and clearly recognize the portions shown on the X-ray film.

Wherein the organism to be analyzed can be not only a human, but also an animal, such that the picture can be the outline of the animal. The picture may further be a side view, a rear view or a front view of the outline of the human or the animal. Additionally, a groove or a protrusion can be added to each of the puzzle pieces 11. For example, a groove may be put on the right side of the puzzle piece with the right hand portion 114, or a groove may be put on the left side of the puzzle piece with the left hand portion 113. If the “right” hand of the patient is to be irradiated by X-ray, the radiologist can accurately take the correct puzzle piece with the right hand portion 114 due to the groove on the right side of the puzzle piece. Accordingly, the probability of picking wrong puzzle pieces can be minimized.

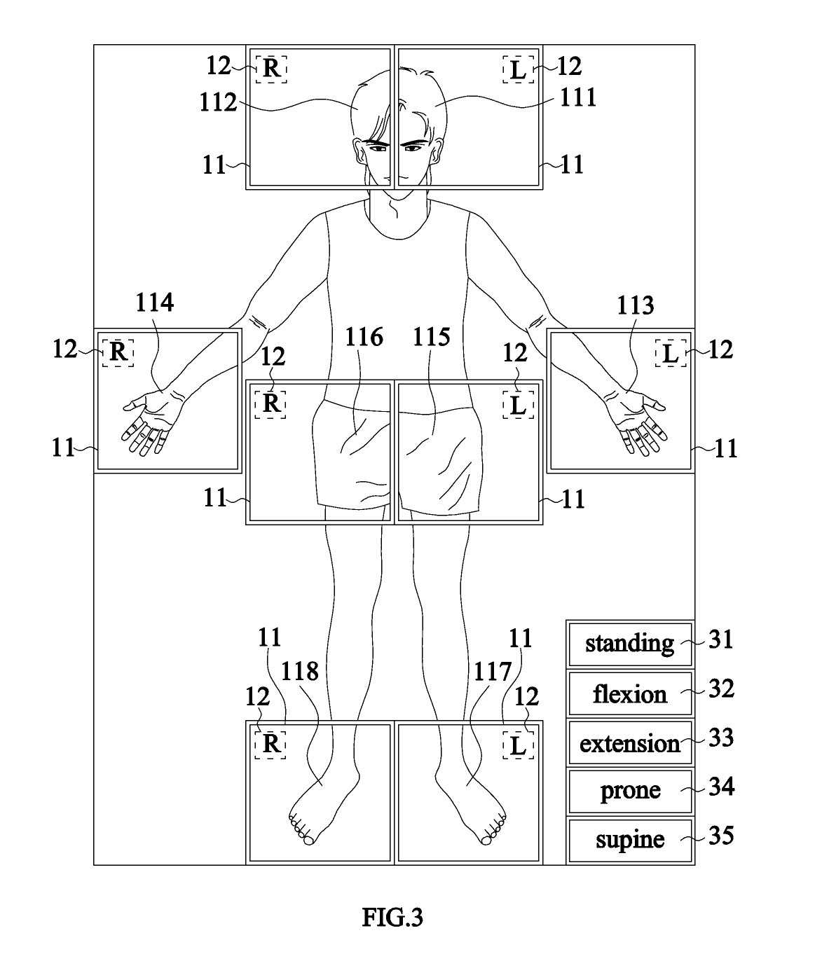

Please refer to FIG. 3, which is a schematic diagram illustrating a recognition device for safely indentifying a left or right portion in a radiologic examination according to the second embodiment of the present invention. As shown, the recognition device may further comprise a puzzle piece mark with “standing” 31, a puzzle piece marked with “flexion” 32, a puzzle piece marked with “extension” 33, a puzzle piece marked with “prone” 34, or a puzzle piece marked with “supine” 35. The radiologists can place the puzzle piece corresponding to the pose of the patient, and the word can be developed on the film to accurately determine the affected part of the patient.

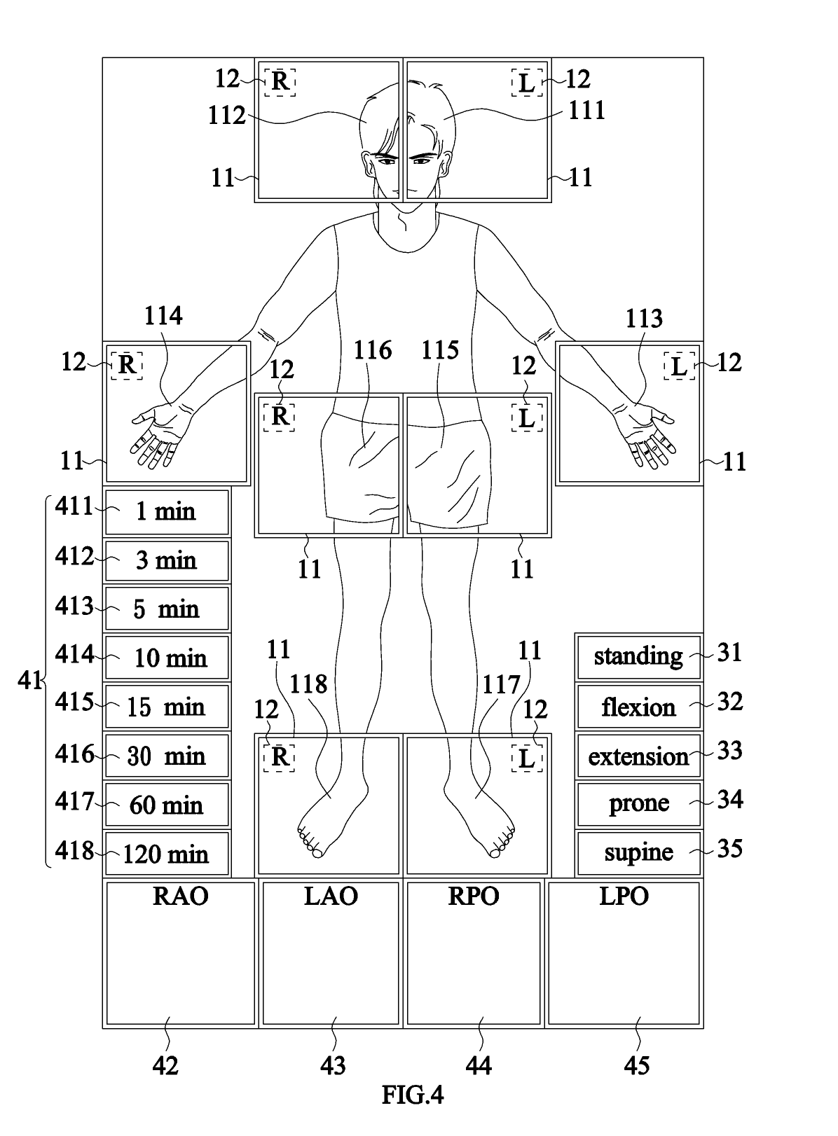

Additionally, the recognition device may further comprise a plurality of puzzle pieces marked with “minute” 41, at least one puzzle piece marked with “right anterior oblique (RAO)” 42, at least one puzzle piece marked with “left anterior oblique (LAO)” 43, at least one puzzle piece marked with “right posterior oblique (RPO)” 44, or at least one puzzle piece marked with “left posterior oblique (LPO)” 45, as shown in FIG. 4. The radiologist can place the puzzle piece corresponding to the position of the patient during radiation with the X-ray. For example, when the patient is irradiated by the X-ray from the left anterior oblique thereof, the puzzle piece marked with “LAO” 43 can be irradiated with the patient by the X-ray. The word “LAO” can be shown on the X-ray film for accurate identification of the position of the irradiated portions of the patient by the radiologist.

“Minute” marked on the plurality of puzzle pieces means the time after taking an oral contrast medium or injection of a contrast medium via intravenous injection. For example, the plurality of puzzle pieces marked with “minute” 41 can be a puzzle piece marked with “1 min” 411, a puzzle piece marked with “3 min” 412, a puzzle piece marked with “5 min” 413, a puzzle piece marked with “10 min” 414, a puzzle piece marked with “15 min” 415, a puzzle piece marked with “30 min” 416, a puzzle piece marked with “60 min” 417 or a puzzle piece marked with “120 min” 418. “Minute” shows that the patient was irradiated by the X-ray one, three, five, ten, fifteen, thirty, sixty, or one hundred twenty minutes after taking the oral contrast medium. After radiation, the “minute” can be shown on the X-ray film to easily show the irradiation time to the radiologists.

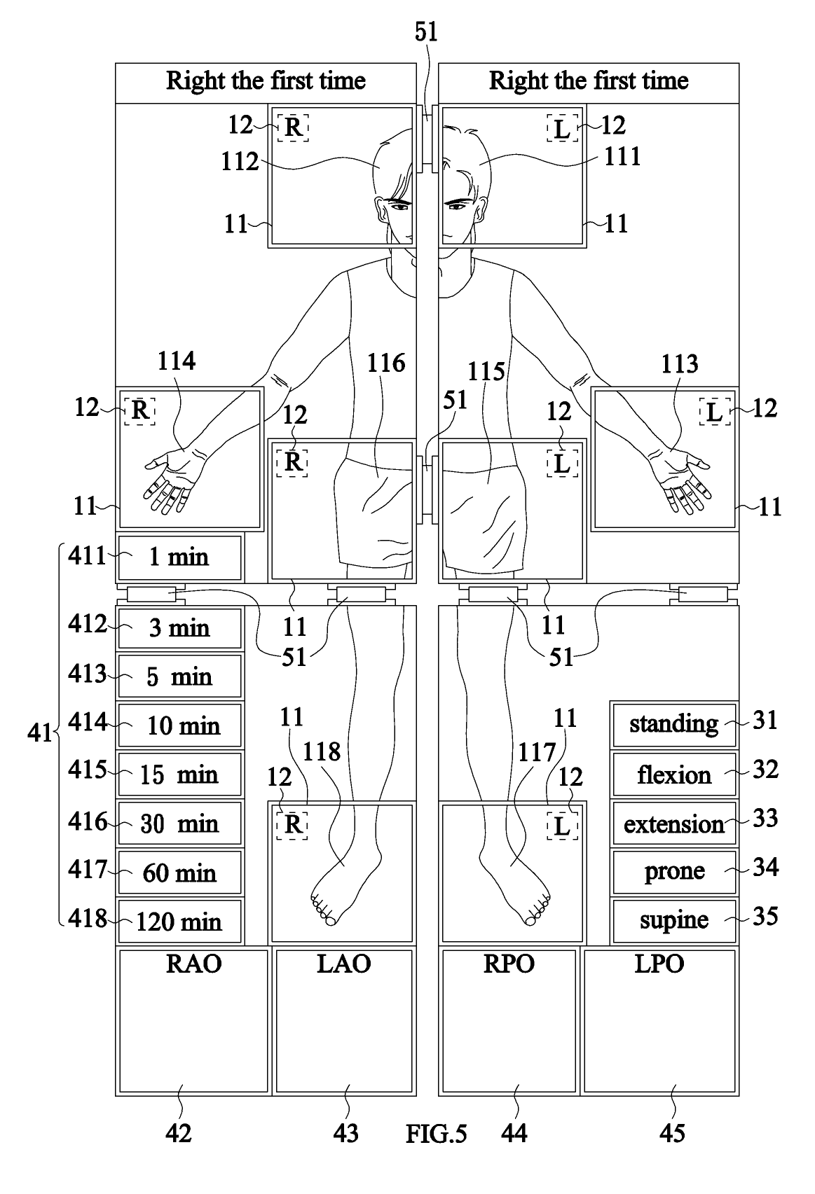

Furthermore, the recognition device may have a plurality of rotary shafts 51, as shown in FIG. 5, such that the recognition device can be made as a folding-type recognition device for easy storage of each of the puzzle pieces for the radiologists. The sentence “Right the first time” may be marked on the top of the recognition device. When the radiologists open the folding-type recognition device, they can become more vigilant in placing the puzzle pieces corresponding to the portion of the patient to be analyzed.

The material of the plurality of labels or the material of the outline of the portions on the puzzle pieces may comprise lead, tantalum, barium, barium sulfate, barium titanate, or a combination thereof. When the labels or the puzzle pieces are irradiated by X-ray, the labels or the outlines can be shown on the film. The material of the puzzle pieces may comprise urethane, an epoxy, a plastic, or latex. One side of each of the puzzle pieces may have an adhesive component, and its material may comprise a plastic, such as polyurethane. Thus the puzzle pieces can be adhered to a hospital bed, an X-ray detector, or a cassette. The adhesive component may be Velcro, and the Velcro can adhere to the clothes of the portion of the patient to be analyzed.

Because the directions of the picture on the plurality of puzzle pieces of the present invention are the same as that of a patient, the radiologists can rapidly and accurately take the correct puzzle pieces corresponding to the portion of the patient to be analyzed. After the puzzle piece and the portion of the patient to be analyzed are simultaneously irradiated by the X-ray, the bone of the portion to be analyzed and the mark or the outline of the portion of the puzzle piece are shown on the film. Therefore, the radiologists can accurately recognize the direction of the image shown on the film to safely identify the affected part of the patient.

The present invention has been described with some preferred embodiments thereof, and it is understood that many changes and modifications in the described embodiments can be carried out without departing from the scope and the spirit of the invention that is intended to be limited only by the appended claims.

What is claimed is:

1. A recognition device for safely indentifying a left or right portion in a radiologic examination, comprising:
a plurality of puzzle pieces, each of the plurality of puzzle pieces comprising a pattern, the pattern being a portion of a picture corresponding to an organism to be analyzed, wherein the portion comprises a left anatomical portion and a right anatomical portion; and
a plurality of labels disposed in the plurality of puzzle pieces or on the plurality of puzzle pieces and corresponding to each of the portions;
wherein, when the plurality of puzzle pieces with the plurality of labels are irradiated by X-ray, an outline of each of the portions or the plurality of labels is developed on a film.

2. The recognition device as claimed in claim 1, further comprising a puzzle piece marked with “standing”, a puzzle piece marked with “flexion”, a puzzle piece marked with “extension”, a puzzle piece marked with “prone”, or a puzzle piece marked with “supine”.

3. The recognition device as claimed in claim 1, further comprising a plurality of puzzle pieces marked with “minute”, at least one puzzle piece marked with “right anterior oblique (RAO)”, at least one puzzle piece marked with “right posterior oblique (RPO)”, at least one puzzle piece marked with “left anterior oblique (LAO)”, or at least one puzzle piece marked with “left posterior oblique (LPO)”.

4. The recognition device as claimed in claim 1, wherein each of the plurality of labels comprises a mark corresponding to the left anatomical portion or the right anatomical portion.

5. The recognition device as claimed in claim 4, wherein the mark comprises a word “left (L)” word or a word “right (R)”.

6. The recognition device as claimed in claim 1, wherein the organism to be analyzed comprises a human or an animal, and the picture corresponding thereto comprises the outline of the human or the animal.

7. The recognition device as claimed in claim 6, wherein the picture corresponding to the organism to be analyzed further comprises a side view, a rear side, or a front view of the outline of the human or the animal.

8. The recognition device as claimed in claim 1, wherein a material of the plurality of labels or a material of the outline of the portions comprises lead, tantalum, barium, barium sulfate, barium titanate, or a combination thereof.

9. The recognition device as claimed in claim 1, wherein a material of the plurality of puzzle pieces comprises urethane, an epoxy, a plastic, or latex.

10. The recognition device as claimed in claim 1, wherein a side of the plurality of puzzle pieces comprises an adhesive object, and a material of the adhesive object comprises a plastic.
